(19) United States
(12) Patent Application Publication
(10) Pub. No.: US 2010/0058453 A1
(43) Pub. Date: Mar. 4, 2010

(54) IDENTIFICATION PROCESS OF APPLICATION OF DATA STORAGE AND IDENTIFICATION HARDWARE WITH IC CARD

(76) Inventor: Hui Lin, Taipei Country (TW)

Correspondence Address: Hui Lin, 235 Chung - Ho, Box 8-24, Taipei, TW

(21) Appl. No.: 12/562,109

(22) Filed: Sep. 17, 2009

Related U.S. Application Data
(63) Continuation-in-part of application No. 10/937,222, filed on Sep. 8, 2004, now abandoned.

(30) Foreign Application Priority Data
Sep. 19, 2003 (TW) 092125964

(51) Int. Cl. H04L 9/00

(52) U.S. Cl. 726/9

(57) ABSTRACT

The present invention relates to an identification process of application of data storage and identification hardware with IC (Integrated Circuit) card, and particularly to an IC card and within identification ICCID and GLN, which can be installed in a USB compatible flash memory, as identification hardware device. This can be as a useful authorization process of records companies or intellectual property owners. The hardware can also be used as storage media. Use non-duplication code in IC card and encryption system to ensure user authentication and data confidentiality on Internet or any other information system of computer. As using normal private key the invention is easy and convenient to use.

The invention is a continuation in part (CIP) of the U. S. patent application Ser. No. 10/937,222 filed at Sep. 8, 2004, invented and assigned to the inventor of the present invention, and thus the contents of the U.S. patent application Ser. No. 10/937,222 is incorporated into the present invention as a part of the specification.

### BACKGROUND OF THE INVENTION

1. Field of the Invention

The present invention relates to an identification process of application of data storage and identification hardware with IC (Integrated Circuit) card, and particularly to an IC card identification process and hardware device of confirming a legal login user's authentication.

2. Description of the Related Art

Since MP3 (MPEG Audio Layer 3) technique was wide known and popular, and P2P (Peer to Peer) files sharing mode on Internet was developed, users can easily search and share music or any other files all over the world. Right now the problems of question of tort of copyright or IP (Intellectual Property) were also appeared. Not only records companies but also IP owners try to create a mechanism of payment of authorized download.

Nowadays most mechanisms of authorization process use simple login system. System server or user himself gives a set of username and password, and uses it to login to access any particular service on Internet. Sometimes AP server (Application server) uses some coding encryption technique but this also cannot prevent the attack by crackers to make sure the safety of data. And for convenient reason, many services provide all over the Internet so that users can use them everywhere. But this also causes illegal using and difficult to trace if user leave the password on the public computer or divulge by back door computer program virus).

In modern time, most crackers often use “Dictionary Attack” to crack legal users' password, so the simple security method by confirming a user's ID and password is not secure, because:

1. Most password are only choice for easy to memorize, not many users use a series random letters and numbers as password. A master of cryptography Daniel Klein believes that “Dictionary Attack” can easily crack more than 40% passwords. There are also many password crack software made by crackers or system professionals on the Internet as a tool for invasion.

2. The information system and network is getting more and more complex; many different systems are connected by network. Thus when a user sign into different systems, due to requirement of each system, a user has to login many times with password(s). According to a statistics, only few users can memorize 3 different sets of 8 characters length passwords. The conclusion is, most users write down the password and store in a convenient place. Obviously, that also becomes a weak point of security.

3. Even without above two weaknesses, but still, a password transfer from the client to server in plain code. A cracker can easily intercept the password at everywhere on the Internet or Local Area Network (LAN), then can fake (Replay) to invade the target system. Even using a dedicated line still switch in a public switch system. For a cracker, that's easier to invade because information on the line is routine so he can concentrate to intercept on the dedicated line.

On the Internet, the communication protocol TCP/IP is used. Two computers on the network should make a Three-way Handing Shaking to set up a connection to transfer data. But this gives a chance to a hidden cracker, because:

1. Information transfer via public Internet is in plain code. Any computer connecting to the Internet can monitor (Sniffing) information that transfers on the network. Thus all the privates and commercial secrets will expose on Internet.

2. To fake user's identity to access remote server, a cracker will also fake as the server to reply mass useless information to user, attempt to tie up operation of client computer (Denial of Service; DoS). A cracker can not only fake a user's identity to access remote service, issue, change, or delete user's data with no aware. And the true user even could not deny that the change was done by himself

Further, when user connects Internet on public computer, the connection is via LAN to Internet. On LAN, Ethernet-based IP network for example, data (Packet) is broadcasting to all PC on LAN. Crackers can intercept data on LAN easily because:

1. Data (Packet) is broadcasting to all PC on LAN in plain code, thus all PC connected on LAN can play a monitor role (Sniffer) to steal others' data.

2. And the worse is, once a password is cracked, system could be unauthorized signed into and changed data, spread fake messages, steal or delete information for commercial or noncommercial reasons . . . etc.

For above problems, the Internet security leak should be mend. One identity confirmation process should be set for double check except for only password.

### SUMMARY OF THE INVENTION

To solve the problems description above, this present invention discloses a method of installing identification hardware within an IC card and setting with a CA server (security mechanism) to satisfy below 5 requirements of information security of electronic data transferring on network:

### 1. Confidentiality:

To make sure information may not be peeped or stolen by a third party to protect users' privacy. This can be done by encryption.

### 2. Integrity:

To make sure information may not be tampered by a third party and can protect correctness of data. This can be done by digital signature or encryption.

### 3. Authentication:

To make sure the source of transferring information may not be faked. This also can be done by digital signature or encryption.

### 4. Non-repudiation:

With digital signature or encryption prevent a user's denying of access.

### 5. Access Control:

Limit users' authority according to identities.

As described above, an IC card device within an Integrated Circuit Card Identification (ICCID) and a Global Number (GLN) is used. With an IC card reader apparatus installed in a compatible Universal Serial Bus (USB) interface hardware is as an identification device. When a user login his username and password to access AP server with the IC card identification hardware device installed in the computer, a program installed within the IC card will make a login process to a CA server to decode the ICCID, compare with the CA identification database, produce an authorized (Validate=Y) EKI value, then decode the value to a KI value and calculate a random value. CA server will encrypt and store KI as the hardware identification successful verification (Server Result). This result can also record the accesses of a user, confirm legitimacy and limits of authority of ICCID of login. When hardware satisfy identification, CA server will send result random value to IC card, and once IC card receive this random value, within program will decode its ICCID to a KI, then encrypt KI and the random value from CA server to result verification (Client Result) for cross-comparing by AP server and CA server. If an IC card fails in cross comparing of authorization (Validate=N), user will be told by system that login failed.

AP server will receive ICCID, Client Result, username, and password when above process is success, then compares login username and password with its database and check avail date first. If correct, AP server will submit ICCID and Client Result to CA server to decrypt and compare with foregoing Server Result. If all matched, user can be confirmed as a legal registrant, and last Server Result will be cleared for next login. If not matched, CA sever will send back a failed message to AP server to reject access.

The downloaded files will be encrypted by program within IC card. Only with the decryption of original IC card can open or play the files. And as described above, crackers can only intercept a changed random value produced from CA server on the network. This value cannot be used as a valid login next time.

The User, AP server, and CA server in this identification system and method form a circle frame. No further process is required for users when login but only an added small program running in login page of AP server. The IC card is the only key that belongs to user as valid verification, with a compliant IC card reader work just simple like key and lock (flash memory with IC card and reader). ICCID was burned as firmware in the chip of IC card. IC card and reader can made compliant to USB interface hardware. This key can be used not only on Internet, but also on single computer as personal security lock. Any public computers, like in offices, schools, or shops, can use this apparatus to protect unauthorized access. For SYSOP (System Operator), this invention can be used to set classification of authorization, like payment mechanism.

### BRIEF DESCRIPTION OF THE DRAWINGS

FIG. 1 is a diagram illustration the operation procedure of the present invention;

FIG. 2 is a diagram showing embodiment of login process of the present invention;

FIG. 3 is a diagram showing embodiment of download process;

FIG. 4 is a diagram illustration the files opening process;

FIG. 5 is a diagram showing embodiment of files opening process;

FIG. 6 is a diagram showing embodiment of identification hardware device;

FIGS. 7 & 8 is a diagram showing embodiment of application of MP3 player; and

FIG. 9 is a diagram illustration plugging into computer chassis of the present invention.

### DETAILED DESCRIPTION OF THE PREFERRED EMBODIMENTS

In the following description, refers to the drawings.

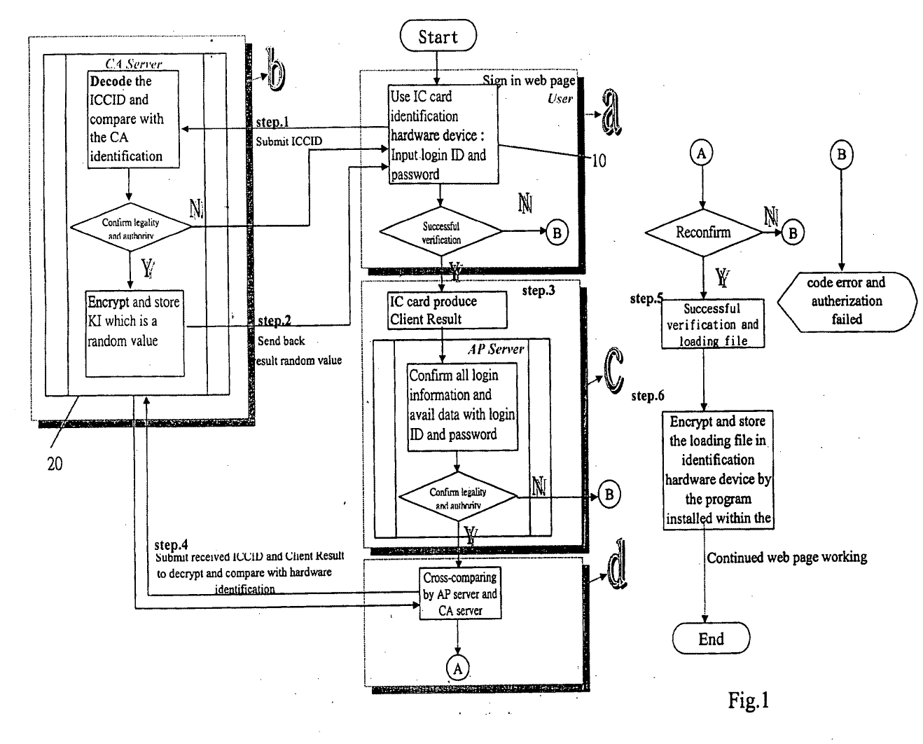

FIG. 1 illustrates procedures of flow sheet of this invention, comprises a, b, c, d four main processes and six procedures from step 1 to step 6 of legal login process.

Process a: Use IC card identification hardware device comprised an IC card and its reader to login AP server. Input login ID and password, then submit.

Process b: IC card transfers login process and ICCID to CA server (step 1). CA server will decode ICCID and compare with its database, confirm legality and authority of ICCID. If it's confirmable, CA server will record in its database and calculate a Server Result, which is a random value, then report this value to IC card (step 2).

Process c: When process b is confirmed, IC card will calculate with random value from CA server and ICCID to a Client Result (step 3), transfer process, ICCID, and Client Result to AP server. With login ID and password, AP server will confirm all login information and avail date.

Process d: When process c is confirmed, AP server will submit received ICCID and Client Result to CA server to decrypt and compare with hardware identification (step 4).

For further description below, in process a, user inserts an IC card, which has within ICCID and GLN code, into a card reader apparatus, which is installed in a flash memory of USB interface as identification hardware device. Using this hardware device to open login process of AP server and then submit login ID and password.

In process b, when user submits ID and password, within program in IC card will transfer ICCID code to CA server. CA server will decode the ICCID, compare with the CA identification database, produce an authorized (Validate=Y) EKI value, then decode the value to a KI value and calculate a random value, encrypt and store KI as the hardware identification successful verification (Server Result). This result can also record the accesses of a user, confirm legitimacy and limits of authority of login AP server of ICCID. When hardware satisfies identification, CA server will send result random value to IC card as a key value. If an IC card fails in cross comparing of authorization (Validate=N), user will be told by system that login failed.

If pass process b, then go to process c. AP server will receive key value and ICCID code of IC card, and submitted login information, then confirm the information and avail date. In process d, when process c confirmed, AP server will send received key and ICCID code to CA server for further confirming. CA server will first decode ICCID, and compare with its database. If this ICCID has a relative valid EKI, use the key value to decode EKI to compare with Server Result. If matched, user can login AP server authorized and CA server will clean out its Server Result for next use. If not matched, CA server will tell AP server ICCID code error and authorization failed.

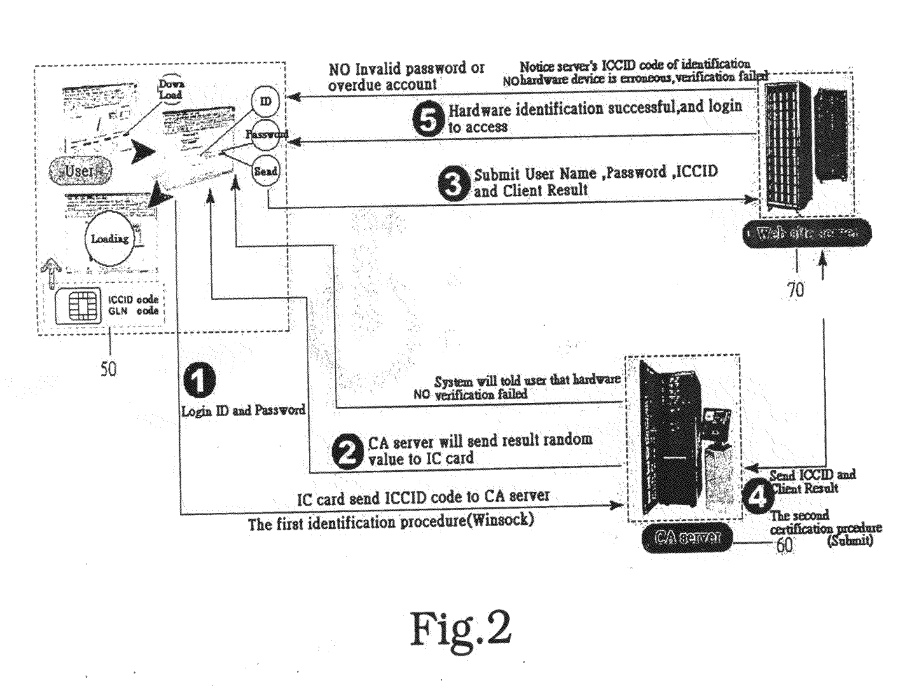

FIG. 2 illustrates substantiation of the present invention. The actual login operation procedure, from submitting to authorization, contains totally 5 routes. Route 1 indicates a user using identification hardware (with IC card) 50 installed in client computer to login AP server 70. User submits login ID and password in login window (can be a web page), which IC card within program will guide login procedure to CA server 60. This is the first identification procedure (Winsock) of the prevent invention. In this process CA server 60 will compare ICCID code and calculate a Server Result. When hardware identification is confirmed, it will lead route 2. In route 2 when IC card receive random value produced form CA server 60, it will calculate and encrypt to a Client Result. This Client Result will be used to compare for AP server in second certification procedure.

When first certification procedure successes, then it will go to route 3. AP server 70 will receive ICCID code, Client Result, and username and password submitted by user who login. If submitted data is correct, route 4, which is preceding second certification procedure, will send ICCID code and Client Result back to CA server 60 to confirm with Server Result. If pass, route 5 will go in CA server 60 to tell AP server 70 certification confirmed. After double check to make sure user is legal, AP server 70 can login to access, and CA server 60 will clean up Server Result. If failed in route 4, AP server 70 will receive a message of ICCID error from CA server 60 and deny to access.

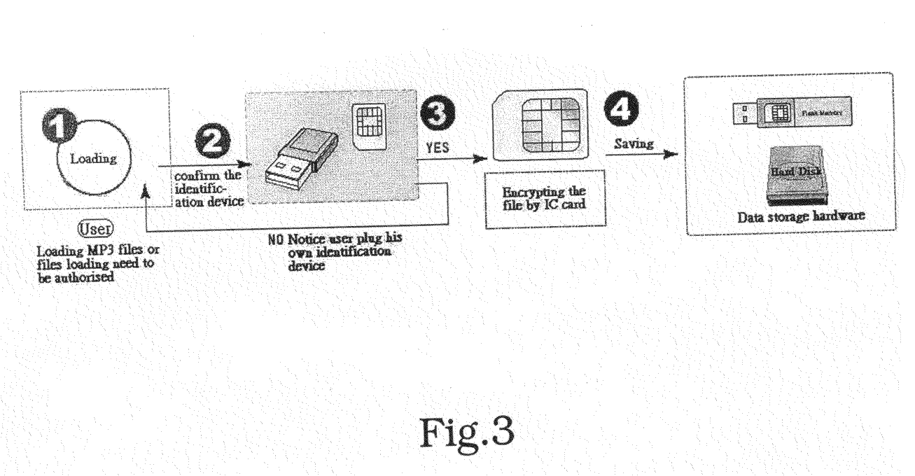

FIG. 3 is a diagram showing embodiment of download process. There are 4 routes in this fig, and in route 2 is the identification mechanism (as shown in FIG. 2).

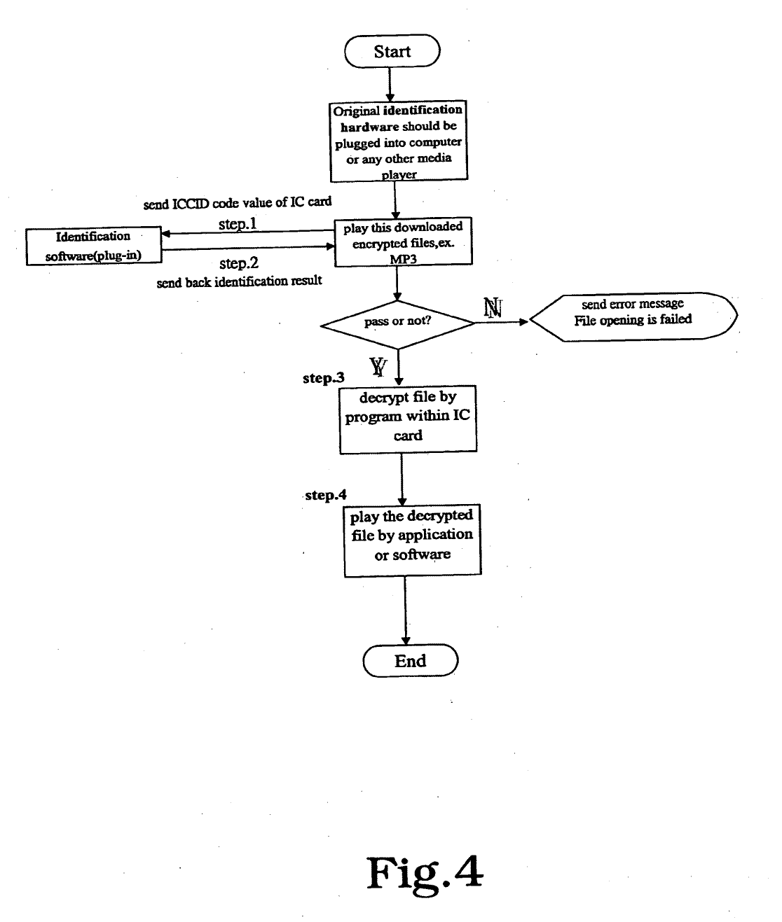

FIG. 4 is a diagram illustration the files opening process of the present invention. As user opens a downloaded, encrypted file, original identification hardware should be plugged into computer or any other media player. When play this downloaded encrypted, MP3 file for example, program within IC card will send ICCID to a plug-in identification software or decode and identify by application of MP3 play which has identification program itself, then identification result will send back to application or software of MP3 play. If identification passes, file will be decrypted by program within IC card and play by application or software; if failed, IC card will send error message.

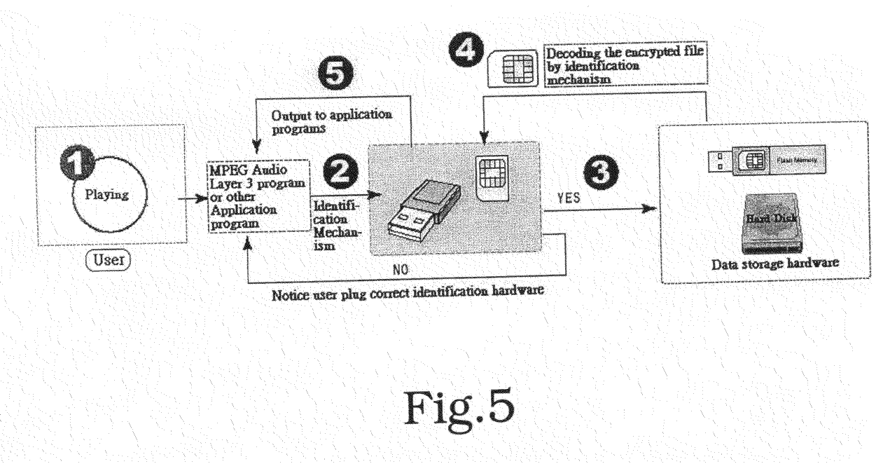

FIG. 5 is a diagram showing embodiment of files opening process. User opens or plays file by plugging his own identification hardware to computer or any other media player which has USB interface, from running software till it working, through 5 routes. Route 2 is the identification process described above.

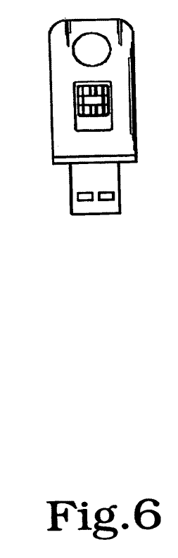

FIG. 6 is a diagram showing embodiment of identification hardware device. IC card device and flash memory are integrated apparatus. Using USB interface device can easily access and work as identification hardware.

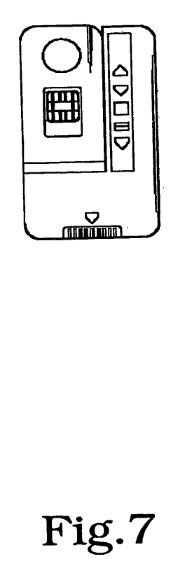

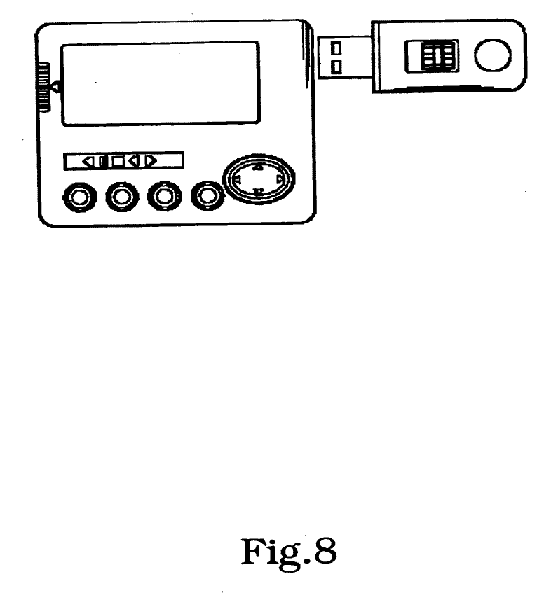

FIGS. 7 & 8 is a diagram showing embodiment of application of MP3 player. It can work as foregoing descriptions.

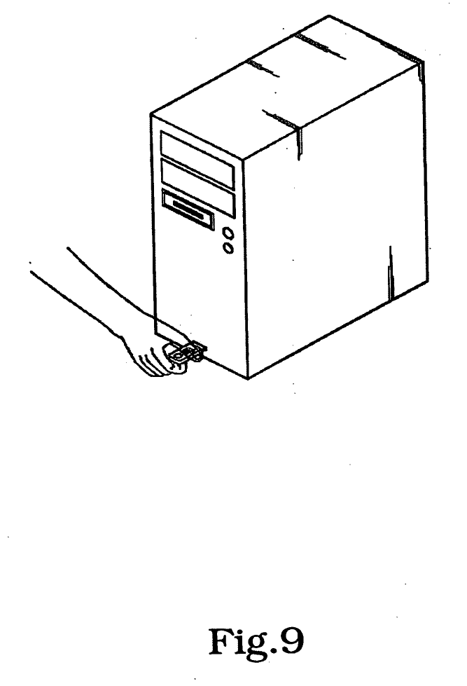

FIG. 9 is a diagram illustration plugging into computer chassis of the present invention. It can work as foregoing descriptions.

The present invention can provide highly standard class security of many AP server service on Internet by encryptions and cross confirming double check system. The IC card identification hardware device can use as a private verification key to access not only on Internet but also many information systems of computer. The foregoing describing of the preferred embodiment of the invention is for the purposes of illustration and description. It is not intended to exhaustive or to limit the invention to the precise from disclosed. Many other possible modifications and variations can be made without departing from the scope of the present invention, which following claims are depended.

What is claimed is:

1. An identification process of data storage and identification hardware with IC card, comprising the process of:
in process a, inserting an IC card having an ICCID code and a GLN code into a card reader apparatus by a user; the card reading apparatus being installed with a flash memory of a USB interface as an identification hardware device for opening a login process of an AP server and then submitting login ID and password;
in process b, submitting ID and password by the user, a program in IC card transferring the ICCID code to a CA server; the CA server decoding the ICCID, comparing the decoded ICCID with codes in a CA identification database of the CA servers, and producing an authorized EKI value, then decoding the EKI value into a KI value and calculating a random value, encrypting and storing the KI value as a hardware identification successful verification (Server Result) which also records accesses of the user, confirming legitimacy and limits of authority of the login AP server of ICCID; when the hardware satisfies identification, the CA server sending a result random value to the IC card as a key value; if the IC card fails in the cross comparing of authorization, the user will be told by system that login is failed;
if passing process b, then go to process c. an AP server receiving the key value and the ICCID code of the IC card, and the submitted login information, then confirming the information; and
in process d, when process c confirmed, the AP server sending the received key and ICCID code to the CA server for further confirming; the CA server firstly decoding the ICCID code, and comparing with its database; if the ICCID code has a relative valid EKI, using the key value to decode the EKI to compare with the Server Result; if matched, user can login the AP server authorized and the CA server cleaning out the Server Result for next use; and if—not matched, the CA server will tell the AP server the ICCID code error and authorization failed.

2. The identification process of application of data storage and identification hardware with IC card of claim 1, wherein the IC card identification hardware device is USB-compliant interface apparatus.

3. The identification process of application of data storage and identification hardware with IC card of claim 1, wherein the IC card identification hardware device is flash memory.
